(19) United States
(12) Patent Application Publication
(10) Pub. No.: US 2020/0287400 A1
(43) Pub. Date: Sep. 10, 2020

(54) BATTERY CONTROL CIRCUIT AND ELECTRONIC DEVICE

(71) Applicant: SHENZHEN ROYOLE TECHNOLOGIES CO. LTD., Shenzhen (CN)

(72) Inventors: Daniel TAO, Shenzhen (CN); Ruihua DONG, Shenzhen (CN)

(73) Assignee: SHENZHEN ROYOLE TECHNOLOGIES CO. LTD., Shenzhen (CN)

(21) Appl. No.: 16/652,500

(22) PCT Filed: Oct. 9, 2017
(86) PCT No.: PCT/CN2017/105385

§ 371 Date: Mar. 31, 2020

(51) Int. Cl. H02J 7/00; H01M 10/44; H01M 10/42

(52) U.S. Cl. CPC H02J 7/0068; H02J 7/0018; H02J 7/007; H01M 10/425; H01M 10/441

(57) ABSTRACT

A battery control circuit is applied to an electronic device having N batteries. The battery control circuit includes: a controller, N power switches, and (N−1) power diodes; one end of the N power switches is respectively connected in series with an output end of the N batteries; the other end of a first power switch is connected to an input end of a power source and the anode of a first power diode respectively; the other end of an i-th power switch is connected to the cathode of an (i−1)-th power diode and the anode of an i-th power diode respectively; the other end of a N-th power switch is connected to the cathode of a (N−1)-th power diode and the power supply end of each electric circuit in the electronic device; N first output ends of the controller are respectively connected to control ends of the N power switches, for controlling an ON/OFF state of the N power switches.

### RELATED APPLICATION

The present application is a National Phase of International Application Number PCT/CN2017/105385, filed Oct. 9, 2017.

### TECHNICAL FIELD

Aspects of the present disclosure relate to electronic technologies and more practically to a battery control circuit and an electronic device.

### BACKGROUND

With the continuous development of Internet technology and the increasing advancement of global terminal product intelligence, more and more electronic devices are used in people's lives and work, such as smart phones, tablet computers, smart speakers, smart air conditioners, and so on.

At present, when supplying power to the system of an electronic device, a dual-battery power supply can be used. First, the main battery is used to power the system. When the power is insufficient, the secondary battery serves as a backup battery to power the system. Also the power may be supplied simultaneously by the main and secondary batteries. When the main and secondary batteries supply power to the system at the same time, the two batteries have a process of charging and discharging each other. Especially when one of the batteries fails, it will seriously affect the battery life and system performance.

### SUMMARY

Accordingly, the embodiments of the present disclosure provide a battery control circuit and an electronic device. By using a controller to control the ON/OFF state of each power switch, power supply to each electric circuit in the system is realized. When two batteries supply power to the system simultaneously, a situation where two batteries charge and discharge each other is avoided, therefore prolonging the battery life and improving the system performance of the electronic device.

The embodiments of the present disclosure have the following technical solutions:

According to the first aspect, the embodiments of the present disclosure provides a battery control circuit, applied to an electronic device having N batteries, the battery control circuit including:

a controller, N power switches, and (N−1) power diodes, where N is a positive integer greater than 1;

one end of the N power switches is respectively connected in series with an output end of the N batteries;

the other end of a first power switch is connected to an input end of a power source and the anode of a first power diode respectively;

the other end of an i-th power switch is connected to the cathode of an (i−1)-th power diode and the anode of an i-th power diode respectively, where i is a positive integer greater than 1 and less than N;

the other end of a N-th power switch is connected to the cathode of a (N−1)-th power diode and the power supply end of each electric circuit in the electronic device;

N first output ends of the controller are respectively connected to control ends of the N power switches, for controlling an ON/OFF state of the N power switches.

The battery control circuit provided in the embodiment of the present disclosure is applied to an electronic device having N batteries, including: a controller, N power switches, and (N−1) power diodes, where N is a positive integer greater than 1; one end of the N power switches is respectively connected in series with an output end of the N batteries; the other end of a first power switch is connected to an input end of a power source and the anode of a first power diode respectively; the other end of an i-th power switch is connected to the cathode of an (i−1)-th power diode and the anode of an i-th power diode respectively, where i is a positive integer greater than 1 and less than N; the other end of a N-th power switch is connected to the cathode of a (N−1)-th power diode and the power supply end of each electric circuit in the electronic device; N first output ends of the controller are respectively connected to control ends of the N power switches, for controlling an ON/OFF state of the N power switches. Therefore, by using the controller to control the ON/OFF state of each power switch, power is supplied to each electric circuit in the system. When two batteries supply power to the system at the same time, the two batteries are prevented from charging and discharging each other, thereby prolonging the service life of the battery and improving the system performance of the electronic device.

According to the second aspect, the embodiments of the present disclosure provide an electronic device including the battery control circuit and N batteries in accordance with the first aspect.

The electronic device provided in the embodiments of the present disclosure includes a battery control circuit and N batteries. The battery control circuit includes: a controller, N power switches, and (N−1) power diodes, where N is a positive integer greater than 1; one end of the N power switches is respectively connected in series with an output end of the N batteries; the other end of a first power switch is connected to an input end of a power source and the anode of a first power diode respectively; the other end of an i-th power switch is connected to the cathode of an (i−1)-th power diode and the anode of an i-th power diode respectively, where i is a positive integer greater than 1 and less than N; the other end of a N-th power switch is connected to the cathode of a (N−1)-th power diode and the power supply end of each electric circuit in the electronic device; N first output ends of the controller are respectively connected to control ends of the N power switches, for controlling an ON/OFF state of the N power switches. Therefore, by using the controller to control the ON/OFF state of each power switch, power is supplied to each electric circuit in the system. When two batteries supply power to the system at the same time, the two batteries are prevented from charging and discharging each other, thereby prolonging the service life of the battery and improving the system performance of the electronic device.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve purposes of illustrative only. One skilled in the art will readily recognize from the following discussion that alternative embodiments of the structures and methods illustrated herein may be employed without departing from the principles of the embodiments described herein.

FIG. 1 is a structural schematic diagram of a battery control circuit in accordance with one embodiment of the present disclosure.

FIG. 2 is a structural schematic diagram of a battery control circuit in accordance with another embodiment of the present disclosure.

FIG. 3 is a structural schematic diagram of an electronic device in accordance with one embodiment of the present disclosure.

### DETAILED DESCRIPTION

The present disclosure will now be described with reference to certain embodiments, examples of which are illustrated in the accompanying drawings. In the following detailed description, numerous particular embodiments are set forth in order to provide a thorough understanding of the principles and practical applications of the present invention. However, it will be understood by those skilled in the art that the detailed description is not intended to be exhaustive or to be limited to the precise forms disclosed. The embodiments are not limited to the precise terms and components disclosed herein. Various modifications or variances may be made in the arrangement, operation, and details of the methods and apparatuses of the embodiments without departing from the spirit and scope of the present invention.

Specifically, the embodiments of the present disclosure, in view of the drawbacks of the prior art, use a dual-battery power supply to power a system of an electronic device. When the main battery and the secondary battery power the system at the same time, there is a charging and discharging process between the two batteries. When one of the batteries fails, it will seriously affect the battery life and system performance. A battery control circuit is introduced. The battery control circuit includes a controller, N power switches, and N−1 power diodes. The battery control circuit controls the ON/OFF state of each power switch by the controller so as to supply the power to each electric circuit in the system. When two batteries power the system at the same time, the situation that two batteries are charged and discharged with each other is avoided. Therefore, the battery life is prolonged, and the system performance of the electronic device is improved.

The following describes a battery control circuit and an electronic device according to embodiments of the present disclosure with reference to the drawings.

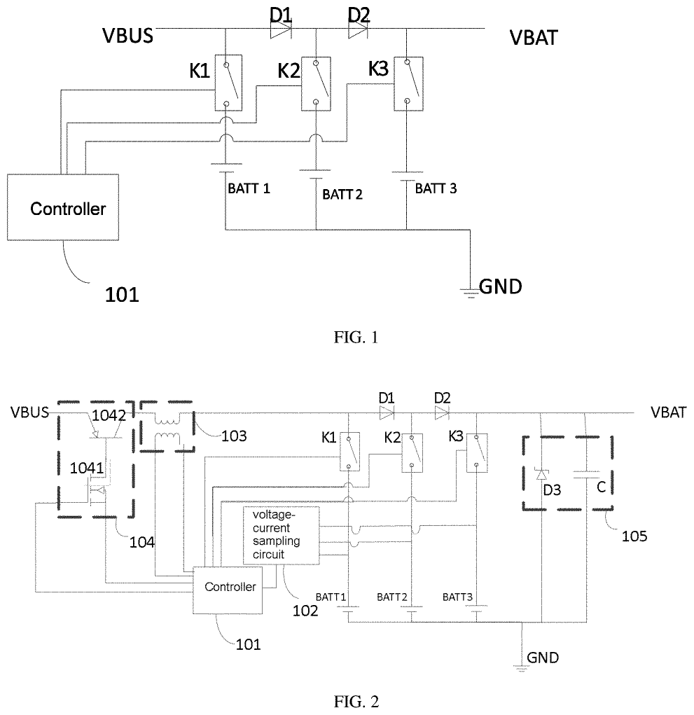

FIG. 1 is a structural schematic diagram of a battery control circuit in accordance with one embodiment of the present disclosure.

As shown in FIG. 1, the battery control circuit is applied to an electronic device with N batteries. The battery control circuit includes a controller 101, N power switches K, and (N−1) power diodes D. N is a positive integer greater than 1.

One end of the N power switches K is respectively connected in series with an output end of the N batteries.

The other end of a first power switch is connected to an input end VBUS of a power source and the anode of a first power diode respectively.

The other end of an i-th power switch is connected to the cathode of an (i−1)-th power diode and the anode of an i-th power diode respectively, wherein i is a positive integer greater than 1 and less than N.

The other end of a N-th power switch is connected to the cathode of a (N−1)-th power diode and the power supply end VBAT of each electric circuit in the electronic device.

N first output ends of the controller 101 are respectively connected to control ends of the N power switches K, and are configured to control an ON and OFF state of the N power switches K.

It should be noted that, in FIG. 1, the electronic device includes three batteries BATT1, BATT2, and BATT3. The control circuit includes three power switches K1, K2, and K3 and two power diodes D1 and D2 as examples.

Specifically, the input end VBUS of the power source is connected to an external charging power source through an adapter or a USB data cable, so as to charge the battery when the battery needs to be charged.

Among them, the power switch can be a transistor, a power multiplexing switch chip, or a miniature DC relay.

In addition, the battery in the embodiments of the present disclosure may be a lithium battery, or a flexible battery, and the type and capacity of the N batteries may be the same or different, which is not limited herein. The other ends of the N batteries are respectively connected to the ground line GND.

Specifically, when the capacities of the N batteries are different, the N batteries in descending order of the capacities are sequentially connected to one end of the first power switch, one end of the second power switch, to one end of the N-th power switch. That is, when the battery capacities of the three batteries BATT1, BATT2, and BATT3 shown in FIG. 1 are different, the capacity of BATT1 is the largest and the capacity of BATT3 is the smallest.

While operating, the controller 101 is configured to:

in a discharging process of the batteries, when the power of a k-th battery does not meet a power supply condition and the power of a (k+1)-th battery meets the power supply condition, control the (k+1)-th power switch to turn on, and after a first preset time interval, control the k-th power switch to turn off, wherein k is a positive integer greater than or equal to 1 and less than or equal to N.

Among them, the power supply condition can be set as needed. Generally, when the voltage between two ends of a battery is greater than a first preset voltage threshold, it is determined that the power of the battery meets the power supply condition; when the voltage between two ends of a battery is less than or equal to the first preset voltage threshold, it is determined that the power of the battery does not meet the power supply condition. The first preset voltage threshold can be set as required.

Specifically, during the power supply process, in order to prevent charging and discharging between batteries when multiple batteries are supplying power at the same time, in the embodiments of the present disclosure, when it is determined that each battery meets a power supply condition, the first power switch is first controlled to be turned on, and the other power switch are disconnected, so as to use the first battery to power each electric circuit in the electronic device. Then, when the power of the first battery does not meet the power supply condition, and the second battery meets the power supply condition, the controller 101 may first control the second power switch to be turned on, then control the first power switch to be turned off, and then switch to use the second battery to power each electric circuit in the electronic device, and successively follow the pattern until the Nth battery is used to power each electric circuit in the electronic device.

In the process of switching from using the k-th battery to using the (k+1)-th battery for power supply, if the k-th power switch is controlled to be turned off first, and then the (k+1)-th power switch is turned on, the system will be powered off as a result. Therefore, in this embodiment, the (k+1)-th power switch is controlled to be turned on first, and then the k-th power switch is controlled to be turned off. In this process, the power of the k-th battery does not meet the power supply condition, and the (k+1)-th battery meets the power supply condition, that is, the voltage of the (k+1)-th battery is greater than the voltage of the k-th battery, so when both the k-th power switch and the (k+1)-th power switch are turned on at the same time, the k-th power diode will not be turned on, that is, during the battery switching process, the situation of mutual charging between batteries will not occur.

Further, in the embodiment of the present disclosure, in order to ensure that the system will not be powered off during the battery switching process, the (k+1)-th power switch can be controlled to be turned on first, and the k-th power switch can be controlled to turn off after a first preset time interval, so when the power of the k-th battery does not meet the power supply condition, the (k+1)-th battery is used to supply power.

Among them, the first preset time interval can be set as required. For example, it can be set to 2 seconds, 3 seconds, and so on as needed.

In specific implementations, taking the battery control circuit shown in FIG. 1 as an example, when the voltage between two ends of the battery is greater than 3.4 volts (V), it is determined that the power of the battery meets the power supply condition. When the voltage between two ends of the battery is less than or equal to 3.4 V, it is determined that the power of the battery does not meet the power supply condition, and the first preset time interval is 3 seconds.

In the charging process, when the voltage between two ends of BATT1 is greater than 3.4V, the controller 101 determines that the power of BATT1 meets the power supply condition. At this time, the controller 101 can control K1 to be on, and K2 and K3 to be off, and power diodes D1 and D2 to be forward conductive, thereby using BAT1 to power each electric circuit of the electronic device. When the voltage between two ends of BATT1 is lower than 3.4V and the voltage between two ends of BATT2 is greater than 3.4V, the controller 101 determines that the power of BATT1 does not meet the power supply condition and the power of BATT2 meets the power supply condition. At this time, the controller 101 can control K2 to turn on and after 3 seconds control K1 to turn off, so as to use BATT2 to supply power to each electric circuit of the electronic device. After K2 is turned on, the power diode D1 can be cut off, thereby reliably preventing BATT2 from charging BATT1. When the voltage between two ends of BATT2 is lower than 3.4V and the voltage between two ends of BATT3 is greater than 3.4V, the controller 101 determines that the power of BATT2 does not meet the power supply condition, and the power of BATT3 meets the power supply condition. At this time, the controller 101 can control K3 to turn on and after 3 seconds control K2 to turn off, so as to use BATT3 to supply power to each electric circuit of the electronic device.

It can be understood that in the battery charging process, when switching from the k-th battery to the (k+1)-th battery for power supply, since the (k+1)-th power switch is controlled to be turned on, then after the first preset time interval, the k-th power switch is controlled to be turned off, so there is a situation where two power switches are turned on at the same time. When the k-th power switch and the (k+1)-th power switch are turned on at the same time, because the voltage of the (k+1)-th battery is higher than the voltage of the k-th battery, the k-th battery cannot charge the (k+1)-th battery. And because the power diode between the k-th power switch and the (k+1)-th power switch is reverse cut off, the (k+1)-th battery cannot charge the k-th battery. Therefore, the situation that two batteries are mutually charged is avoided, the battery life is prolonged, and the performance of the system is improved.

Through the above analysis, it can be known that the controller 101 can be used to control the ON/OFF state of each power switch to achieve the power supply of each battery to each electric circuit in the system. The following description explains the use of the controller 101 to control the ON/OFF state of each power switch to achieve the process of charging each battery. Specifically, the controller 101 is configured to:

in a charging process, in response to determining that both a j-th battery and a (j+1)-th battery meet a charging condition, control the (j+1)-th power switch to turn on to charge the (j+1)-th battery, wherein j is a positive integer greater than or equal to 1 and less than or equal to N;

in response to determining that the charging of the (j+1)-th battery is complete, control the j-th power switch to turn on, and after a second preset time interval, control the (j+1)-th power switch to turn off.

Among them, the charging condition can be set as required. Generally, when the voltage between two ends of a battery is less than a second preset voltage threshold, it is determined that the power of the battery meets the charging condition; when the voltage between two ends of a battery is greater than or equal to the second preset voltage threshold, it is determined that the power of the battery does not meet the charging condition. The second preset voltage threshold can be set as required.

In addition, during the charging of a battery, different stages of charging, such as pre-charging, constant current, constant voltage, and trickle, are performed. In different charging stages, the voltage between two ends of the battery and the current flowing into the battery, i.e., the charging current are different, so whether the battery is charged or not may be determined according to the voltage between two ends of the battery and the current flowing into the battery. For example, when the voltage between two ends of a battery is greater than 4.2V and the current flowing into the battery is close to 0, it can be determined that the battery is fully charged.

It can be understood that, in the embodiment of the present disclosure, if all N batteries meet the charging condition, the charging order of the N batteries starts from the N-th battery, and after the N-th battery is charged, the (N−1)-th battery is charged. After the (N−1)-th battery is charged, the (N−2)-th battery is charged until the first battery is charged.

That is, when all N batteries meet the charging condition, the controller 101 can control the N-th power switch to be turned on and other power switches to be turned off, so as to charge the N-th battery. Then, after the charging of the N-th battery is completed, the controller 101 can switch to charging the (N−1)-th battery by controlling the ON/OFF state of the (N−1)-th power switch, and so on until the charging of the first battery is completed.

Because when the charging of the (j+1)-th battery is completed, the power is switched from charging the (j+1)-th battery to charging the j-th battery, if the (j+1)-th power switch is controlled to be turned off first, then the j-th power switch is turned on, the instantaneous current in the circuit will be too large, resulting in unstable circuit and poor safety. Therefore, in the embodiment of the present disclosure, the j-th power switch can be controlled to be turned on first to charge the j-th battery, and then the (j+1)-th power switch can be controlled to be turned off after the second preset time interval, so as to turn off the connection between the (j+1)-th battery and the charging circuit.

When the j-th power switch and (j+1)-th power switch are both on, the j-th power diode in connection between them has the anode voltage lower than the cathode voltage, so the j-th power diode is in the reverse cut-off state, therefore preventing the (j+1)-th battery from being charged.

Among them, the second preset time interval can be set as required. For example, it can be set to 2 s, 3 s, and so on as needed.

For specific implementations, the battery control circuit shown in FIG. 1 is used as an example. If the voltage between two ends of a battery is less than 4.2V, the battery needs to be charged. When the voltage between two ends of a battery is greater than or equal to 4.2V, the battery doesn't need to be charged. When the voltage between two ends of a battery is greater than or equal to 4.2V, and the current flowing into the battery is close to 0, the charging of the battery ends. The second preset time interval is 3 s.

When the input end VBUS of the power source is connected to USB and the charging process is performed for each battery, when the voltages between two ends of BATT1, BATT2, and BATT3 are all less than 4.2V, the controller 101 determines that BATT1, BATT2, and BATT3 all need to be charged. At this time, the controller 101 controls K3 to turn on and K1 and K2 to turn off, so as to charge BAT3. When the voltage between two ends of BATT3 is greater than 4.2V and the current flowing into BATT3 is close to 0, the controller 101 determines that the charging of BATT3 is completed. At this time, the controller 101 can control K2 to be turned on, and control K3 to be turned off after 3 seconds, thereby charging BATT2. When the voltage between two ends of BATT2 is greater than 4.2V and the current flowing into BATT2 is close to 0, the controller 101 determines that the charging of BATT2 is completed. At this time, the controller 101 can control K1 to be turned on and control K2 to be turned off after 3 seconds, thereby charging BATT1.

It can be understood that in the battery charging process, when switching from charging the (j+1)-th battery to charging the j-th battery, because the j-th power switch is controlled to be turned on, and then after the second preset time interval, the (j+1)-th power switch is controlled to be turned off, so there is a situation where two power switches are turned on at the same time. When the (j+1)-th power switch and the j-th power switch are turned on at the same time, because the voltage of the (j+1)-th battery is higher than the voltage of the j-th battery, the j-th battery cannot charge the (j+1)-th battery. And because the power diode between the j-th power switch and the (j+1)-th power switch is reverse cut off, the (j+1)-th battery will not charge the j-th battery. Therefore, the situation that the two batteries are mutually charged is avoided, the battery life is prolonged, and the performance of the system is improved.

From the above analysis, it can be known that the controller 101 can control the ON/OFF state of each power switch according to the voltage between two ends of each battery, the current flowing into each battery, i.e., the charging current, etc., to charge or discharge each battery. In one implementation of the present disclosure, as shown in FIG. 2, the battery control circuit may further include a voltage-current sampling circuit 102 for collecting a voltage between two ends of each battery and detecting a charging and/or discharging current of the battery. Therefore, the output value of the voltage-current sampling circuit 102 may be at least one of a battery voltage, a charging current, or a discharge current.

The input end of the voltage-current sampling circuit 102 is respectively connected to the output ends of the N batteries, and the output end of the voltage-current sampling circuit 102 is connected to the first input end of the controller 101.

The controller 101 is configured to determine state of each of the N batteries according to the output values of the voltage-current sampling circuit 102 so as to control the ON/OFF state of each of the N power switches K.

The voltage-current sampling circuit 102 is a circuit that can collect the voltage between two ends of a battery, which is not limited here.

Specifically, the voltage-current sampling circuit 102 can collect the voltage between two ends of each of the N batteries and output the voltage between two ends of each battery to the controller 101, so that the controller 101 can control the ON/OFF states of the N power switches K, during the charging and discharging processes, according to the voltage so as to use each battery to supply power or to charge each battery.

In addition, when charging the battery, in order to determine whether the charging of the battery is completed and to control the ON/OFF state of each power switch, it is also necessary to detect the magnitude of the charging current. Therefore, in the embodiment of the present disclosure, the battery control circuit may further include a current detection circuit 103 to detect the magnitude of the charging current.

The current detection circuit 103 is connected in series between the charging control circuit and the other end of the first power switch, and the output end of the current detection circuit 103 is connected to the input end of the controller 101.

Among them, the current detection circuit 103 may be any circuit that can detect a current. For example, the current detection circuit 103 may be composed of resistors. When the resistance value Rsense of the resistor is known, the voltage Vsense between two ends of the resistor is detected to determine the magnitude of the charging current Isense according to a formula: Isense=Vsense/Rsense. Alternatively, the current detection circuit 103 may be composed of a current transformer, and detects the magnitude of the charging current by converting the large current on the primary side into a small current on the secondary side by the current transformer.

FIG. 2 illustrates a current detection circuit 103 composing current transformers.

Specifically, in the process of charging a battery, the controller 101 can determine the magnitude of the charging current according to the output value of the current detection circuit 103, and determine the magnitude of the voltage between two ends of the battery according to the output value of the voltage-current sampling circuit 102, thereby determining the charging state of the battery. If it is determined that the charging of the battery is completed, the other batteries can be charged by controlling the ON/OFF state of each power switch.

Further, in the process of charging a battery, the controller 101 may also control the charging current of the battery according to the voltage between two ends of the battery so as to charge the battery at different stages. As such, in embodiments of the present disclosure, a charging control circuit 104 may be included.

The charging control circuit 104 is connected in series between the input end of the power source and the other end of the first power switch.

The control end of the charging control circuit 104 is connected to the second output end of the controller 101.

The controller 101 is further configured to control a charging current by controlling an operating state of the charging control circuit 104.

Among them, the charging control circuit 104 is any circuit that can control the magnitude of the charging current, which is not limited here.

Specifically, FIG. 2 illustrates that the charging control circuit 104 includes an N-type metal oxide semiconductor field effect transistor (MOSFET) 1041 and a PNP-type transistor 1042 as an example.

It should be noted that the MOSFET 1041 and the transistor 1042 can be of any type, which is not limited herein.

Among them, a gate of the MOSFET is connected to a third output end of the controller 101, a source of the MOSFET is connected to a fourth output end of the controller 101, and a drain of the MOSFET is connected to a base of the transistor;

An emitter of the transistor is connected to the input end of the power source, a collector of the transistor is connected to the other end of the first power switch and the anode of the first power diode.

In a specific implementation, the controller 101 controls the ON/OFF state of each power switch to charge a battery. By controlling the duty cycles of the MOSFET 1041 and the transistor 1042 of the charging control circuit 104, the charging current can be adjusted so as to charge the battery at different stages such as pre-charging, constant current, constant voltage, trickle and so on.

It should be noted that in the process of charging a battery, the controller 101 can also determine the actual charging current of the battery through the output value of the current detection circuit 103, so that when the actual charging current of the battery is different from the expected charging current, the operating state of the charging control circuit 104 is controlled to adjust the charging current of the battery.

In addition, the controller 101 can also determine whether each battery has malfunctioned or failed, through the output value of the current detection circuit 103, so that when a battery malfunctions or fails, it actively cuts off the battery and outputs an alarm message such that the user can repair it in time. As a result, the charging process of the battery is more secure, and the system can still work normally when a battery fails, which improves the safety and reliability of the electronic device.

It is worth noting that in practice, surges may occur in the battery control circuit. In order to ensure that the voltage in the circuit is within a reasonable range, in the embodiment of the present disclosure, as shown in FIG. 2, the battery control circuit may include a surge voltage protection circuit 105.

One end of the surge voltage protection circuit 105 is connected to the power supply end VBAT of each electric circuit in the electronic device, and the other end of the surge voltage protection circuit 105 is connected to the ground line GND.

Among them, the surge voltage protection circuit 105 may be composed of any surge protection device such as a gas discharge tube, a varistor, and a TVS transient suppression diode. FIG. 2 illustrates that the surge voltage protection circuit 105 includes a Zener diode D3 and a capacitor C as an example.

Specifically, when the voltage in the circuit is normal, the surge voltage protection circuit 105 has no effect on the circuit operation; when a high pulse voltage arrives, the surge voltage protection circuit 105 can bypass the surge energy to ensure that the voltage of the circuit is within a reasonable range, thereby protecting the back-end circuit from surge impacts.

It can be understood that the battery control circuit provided in the embodiment of the present disclosure can independently charge and discharge each battery, and the charging process does not interfere with each other, thereby preventing overcharging and over-discharging, extending battery life, and sharing N batteries with the same charging control circuit 104, current detection circuit 103, and voltage-current sampling circuit 102, saving stacking space and helping increase battery capacity.

The battery control circuit provided in the embodiment of the present disclosure is applied to an electronic device having N batteries, including: a controller, N power switches, and (N−1) power diodes, where N is a positive integer greater than 1; one end of the N power switches is respectively connected in series with an output end of the N batteries; the other end of a first power switch is connected to an input end of a power source and the anode of a first power diode respectively; the other end of an i-th power switch is connected to the cathode of an (i−1)-th power diode and the anode of an i-th power diode respectively, where i is a positive integer greater than 1 and less than N; the other end of a N-th power switch is connected to the cathode of a (N−1)-th power diode and the power supply end of each electric circuit in the electronic device; N first output ends of the controller are respectively connected to control ends of the N power switches, for controlling an ON/OFF state of the N power switches. Therefore, by using the controller to control the ON/OFF state of each power switch, power is supplied to each electric circuit in the system. When two batteries supply power to the system at the same time, the two batteries are prevented from charging and discharging each other, thereby prolonging the service life of the battery and improving the system performance of the electronic device.

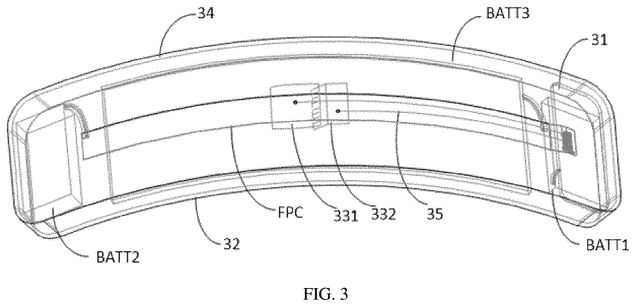

FIG. 3 is a schematic structural diagram of an electronic device in accordance with one embodiment of the present disclosure.

As shown in FIG. 3, the electronic device includes: a battery control circuit and N batteries.

FIG. 3 illustrates that the electronic device includes three batteries: lithium battery BATT1, lithium battery BATT2, and flexible battery BATT3. The battery control circuit is not shown in FIG. 3.

The electronic device may be any electronic device such as a mobile phone, a wearable device, and a smart speaker, and is not specifically limited herein.

In addition, the electronic device may further include a main board 31 and a flexible printed circuit board (FPC).

Specifically, each component of the battery control circuit may be provided on the main board 31, and three batteries may be connected to the corresponding power switch on the main board 31 through an FPC. For the structure and working principle of the battery control circuit, reference may be made to the explanations of the foregoing embodiments, and details are not described herein again.

Further, as shown in FIG. 3, the electronic device may include a bendable flexible housing 32 and a pair of elastic plates 33 symmetrically disposed on both sides of a bendable portion of the flexible housing 32. The pair of elastic plates 33 include a first elastic plate 331 and a second elastic plate 332.

When the flexible housing 32 is in a first state, two elastic plates of the pair of elastic plates 33 are in a reliable contact; when the flexible housing 32 is in a second state, the two elastic plates of the pair of elastic plates 33 are separated, where the first state is a bent state and the second state is a flat state.

The first elastic plate 331 of the pair of elastic plates 33 is connected to the power source in the electronic device, and the second elastic plate 332 is connected to the input end of the controller 101 of the battery control circuit;

The controller 101 is configured to, according to a voltage value on the second elastic plate 332, control a display state and a content of a display screen 34 of the electronic device.

The power source in the electronic device may be any battery controlled by the above-mentioned battery control circuit, or may be another battery in the electronic device, which is not limited herein.

The first elastic plate 331 can be connected to the power source on the main board 31 through a cable 35, and the second elastic plate 332 can be connected to the input end of the controller 101 on the main board 31 through the cable 35.

It should be noted that, in the embodiment of the present disclosure, the pair of elastic plates symmetrically disposed on both sides of the bent portion of the flexible housing 32 may be one pair or multiple pairs, which is not limited herein.

Specifically, an angle threshold may be set in advance. When the angle at which the flexible housing 32 of the electronic device is bent exceeds a preset angle threshold, it is determined that the flexible housing 32 is in a bent state; when the angle at which the flexible housing 32 of the electronic device is bent is less than the preset angle threshold, it is determined that the flexible housing 32 is in a flat state.

The display state of the display screen 34 may include a size of a display interface, a size of displayed font, a font color, and the like.

It can be understood that, in the embodiments of the present disclosure, the flexible housing 32 of the electronic device may be preset in different states, and the display states and contents of the corresponding display screens 34 are different. For example, when the flexible housing 32 is bent less than 60 degrees, the electronic device is used as a mobile phone, and the content displayed on the display screen 34 is large, and the font is small; when the flexible housing 32 is bent more than 60 degrees, the electronic device is used as a hand ring, and the content displayed on the display screen 34 is less, and the font is larger. Therefore, when the user based on needs bends the flexible housing 32 of the electronic device to different degrees so that the flexible housing 32 is in different states, the electronic device display screen can have different display states and contents to meet different needs of the user.

In specific implementations, when the flexible housing 32 is in a bent state, the two elastic plates of the pair of elastic plates 33 are reliably contacted, and because the first elastic plate 331 of the pair of elastic plates 33 is connected to the power source in the electronic device, the voltage value of the second elastic plate 332 is the voltage value of the power source; when the flexible housing 32 is in the flat state, the two elastic plates of the pair of elastic plates 33 are separated, so the voltage value of the other elastic plate 332 is 0. That is, when the flexible housing 32 is in a different state, the voltage value of the other elastic plate 332 is different, so that the controller 101 can determine the state of the flexible housing 32 according to the voltage value of the other elastic plate 332, and then can control the display 34 of the electronic device to display in different display states and different contents.

The electronic device provided by the embodiment of the present disclosure can use N batteries for power supply, which increases the battery capacity, increases the battery life and the use time; N batteries share the same charging control circuit 104, current detection circuit 103, and voltage-current sampling circuit 102, thereby saving stacking space and increasing the battery capacity; the electronic device has a bend detection function, so that the display state and content of the display screen 34 can be easily switched, and the operability and practicability are more abundant and reasonable.

It should be noted that, in the electronic device provided by the embodiment of the present disclosure, the display screen 34 may include a flexible touch screen (Touch Panel, TP) and a flexible screen bonded to the flexible housing 32. The flexible TP and the flexible screen are connected with the main board 31 through the FPC such that the main board 31 can communicate with the flexible TP and the flexible screen and control the flexible TP and the flexible screen.

In addition, the main board 31 may further include a baseband chip, a power source management chip, a memory chip, a battery charging and discharging circuit, a battery detection circuit, a radio frequency circuit, a TP and flexible screen driving circuit, an acceleration sensor, a gravity sensor, a proximity light sensor, and the like.

The electronic device provided in the embodiments of the present disclosure includes a battery control circuit and N batteries. The battery control circuit includes: a controller, N power switches, and (N−1) power diodes, where N is a positive integer greater than 1; one end of the N power switches is respectively connected in series with an output end of the N batteries; the other end of a first power switch is connected to an input end of a power source and the anode of a first power diode respectively; the other end of an i-th power switch is connected to the cathode of an (i−1)-th power diode and the anode of an i-th power diode respectively, where i is a positive integer greater than 1 and less than N; the other end of a N-th power switch is connected to the cathode of a (N−1)-th power diode and the power supply end of each electric circuit in the electronic device; N first output ends of the controller are respectively connected to control ends of the N power switches, for controlling an ON/OFF state of the N power switches. Therefore, by using the controller to control the ON/OFF state of each power switch, power is supplied to each electric circuit in the system. When two batteries supply power to the system at the same time, the two batteries are prevented from charging and discharging each other, thereby prolonging the service life of the battery and improving the system performance of the electronic device.

While the present disclosure has been described with reference to certain embodiments, it will be understood by those skilled in the art that various changes may be made and equivalents may be substituted without departing from the scope of the present invention. The disclosure of the embodiments is for purposes of illustrative only, and is not intended for limiting the scope of the present invention. Also, it is appreciated that the previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A battery control circuit, applied to an electronic device with N batteries, comprising a controller, N power switches, and (N−1) power diodes, wherein N is a positive integer greater than 1, wherein:
one end of each of the N power switches is respectively connected in series with an output end of each of the N batteries;
the other end of a first power switch is connected to an input end of a power source and an anode of a first power diode respectively;
the other end of an i-th power switch is connected to a cathode of an (i−1)-th power diode and an anode of an i-th power diode respectively, wherein i is a positive integer greater than 1 and less than N;
the other end of a N-th power switch is connected to a cathode of a (N−1)-th power diode and a power supply end of each electric circuit in the electronic device;
N first output ends of the controller are respectively connected to control ends of the N power switches, and are configured to control an ON/OFF state of the N power switches.

2. The battery control circuit according to claim 1, wherein the N batteries have different capacities, the N batteries in descending order of the capacities are sequentially connected to one end of the first power switch, one end of the second power switch, to one end of the N-th power switch.

3. The battery control circuit according to claim 2, wherein the controller is further configured to:
in a discharging process, when power of a k-th battery does not meet a power supply condition and power of a (k+1)-th battery meets the power supply condition, control the (k+1)-th power switch to turn on, and after a first preset time interval, control the k-th power switch to turn off, wherein k is a positive integer greater than or equal to 1 and less than or equal to N.

4. The battery control circuit according to claim 2, wherein the controller is further configured to:
in a charging process, in response to determining that both a j-th battery and a (j+1)-th battery meet a charging condition, control the (j+1)-th power switch to turn on to charge the (j+1)-th battery, wherein j is a positive integer greater than or equal to 1 and less than or equal to N;
in response to determining that the charging of the (j+1)-th battery is completed, control the j-th power switch to turn on, and after a second preset time interval, control the (j+1)-th power switch to turn off.

5. The battery control circuit according to claim 1, further comprising a voltage-current sampling circuit, wherein
input ends of the voltage-current sampling circuit are respectively connected to the output ends of the N batteries, output ends of the voltage-current sampling circuit are connected to first input ends of the controller;
the controller is configured to, based on an output value of the voltage-current sampling circuit, determine a state of the N batteries to control the ON/OFF state of the N power switches.

6. The battery control circuit according to claim 1, further comprising a charging control circuit connected in series between the input end of the power source and the other end of the first power switch,
wherein a control end of the charging control circuit is connected to a second output end of the controller;
the controller is further configured to, by controlling an operating state of the charging control circuit, control a charging current.

7. The battery control circuit according to claim 6, further comprising a current detection circuit connected in series between the charging control circuit and the other end of the first power switch,
wherein an output end of the current detection circuit is connected to an input end of the controller;
the controller is further configured to, based on an output value of the current detection circuit, control the operating state of the charging control circuit.

8. The battery control circuit according to claim 6, wherein the charging control circuit comprises a metal oxide semiconductor field effect transistor (MOSFET) and a transistor;
a gate of the MOSFET is connected to a third output end of the controller, a source of the MOSFET is connected to a fourth output end of the controller, a drain of the MOSFET is connected to a base of the transistor;
an emitter of the transistor is connected to the input end of the power source, a collector of the transistor is connected to the other end of the first power switch and the anode of the first power diode.

9. The battery control circuit according to claim 1, further comprising a surge voltage protection circuit,
wherein one end of the surge voltage protection circuit is connected to the power supply end of each of the electric circuits of the electronic device, and the other end of the surge voltage protection circuit is connected to a ground wire.

10. An electronic device comprising the battery control circuit according to claim 1 and N batteries.

11. The electronic device according to claim 10, further comprising a bendable flexible housing and a pair of elastic plates symmetrically disposed on both sides of a bendable portion of the flexible housing,
wherein when the flexible housing is in a first state, two elastic plates of the pair of elastic plates are in contact; when the flexible housing is in a second state, the two elastic plates of the pair of elastic plates are separated, wherein the first state is a bent state and the second state is a flat state;
one elastic plate of the pair of elastic plates is connected to the power source in the electronic device, and the other elastic plate of the pair of elastic plates is connected to the input end of the controller of the battery control circuit;
the controller is configured to, according to a voltage value on the other elastic plate, control a display state and a content of a display screen of the electronic device.

12. The electronic device according to claim 10, wherein the N batteries have different capacities, the N batteries in descending order of the capacities are sequentially connected to one end of the first power switch, one end of the second power switch, to one end of the N-th power switch.

13. The electronic device according to claim 12, wherein the controller is further configured to:
in a discharging process, when power of a k-th battery does not meet a power supply condition and power of a (k+1)-th battery meets the power supply condition, control the (k+1)-th power switch to turn on, and after a first preset time interval, control the k-th power switch to turn off, wherein k is a positive integer greater than or equal to 1 and less than or equal to N.

14. The electronic device according to claim 12, wherein the controller is further configured to:
in a charging process, in response to determining that both a j-th battery and a (j+1)-th battery meet a charging condition, control the (j+1)-th power switch to turn on to charge the (j+1)-th battery, wherein j is a positive integer greater than or equal to 1 and less than or equal to N;
in response to determining that the charging of the (j+1)-th battery is completed, control the j-th power switch to turn on, and after a second preset time interval, control the (j+1)-th power switch to turn off.

15. The electronic device according to claim 10, further comprising a voltage-current sampling circuit, wherein
input ends of the voltage-current sampling circuit are respectively connected to the output ends of the N batteries, output ends of the voltage-current sampling circuit are connected to first input ends of the controller;
the controller is configured to, based on an output value of the voltage-current sampling circuit, determine a state of the N batteries to control the ON/OFF state of the N power switches.

16. The electronic device according to claim 10, further comprising a charging control circuit connected in series between the input end of the power source and the other end of the first power switch,
wherein a control end of the charging control circuit is connected to a second output end of the controller;
the controller is further configured to, by controlling an operating state of the charging control circuit, control a charging current.

17. The electronic device according to claim 16, further comprising a current detection circuit connected in series between the charging control circuit and the other end of the first power switch,
wherein an output end of the current detection circuit is connected to an input end of the controller;
the controller is further configured to, based on an output value of the current detection circuit, control the operating state of the charging control circuit.

18. The electronic device according to claim 16, wherein the charging control circuit comprises a metal oxide semiconductor field effect transistor (MOSFET) and a transistor;
a gate of the MOSFET is connected to a third output end of the controller, a source of the MOSFET is connected to a fourth output end of the controller, a drain of the MOSFET is connected to a base of the transistor;
an emitter of the transistor is connected to the input end of the power source, a collector of the transistor is connected to the other end of the first power switch and the anode of the first power diode.

19. The electronic device according to claim 10, further comprising a surge voltage protection circuit,
wherein one end of the surge voltage protection circuit is connected to the power supply end of each of the electric circuits of the electronic device, and the other end of the surge voltage protection circuit is connected to a ground wire.
